(19) United States
(12) Patent Application Publication
(10) Pub. No.: US 2016/0257492 A1
(43) Pub. Date: Sep. 8, 2016

(54) GARBAGE CAN HAVING RECESSED LID

(71) Applicant: Camille Landi, Oceanside, NY (US)

(72) Inventor: Camille Landi, Oceanside, NY (US)

(21) Appl. No.: 15/058,043

(22) Filed: Mar. 1, 2016

Related U.S. Application Data
(60) Provisional application No. 62/127,082, filed on Mar. 2, 2015.

(51) Int. Cl. B65F 1/16

(52) U.S. Cl. CPC B65F 1/1623; B65F 1/1615

(57) ABSTRACT

A garbage can includes a lid recess including a first recessed sidewall, a second recessed sidewall and a third recessed sidewall. The lid recess is formed in an upper surface of the garbage can. A cross-beam is disposed across the upper surface of the garbage can between the first recessed sidewall and the third recessed sidewall. A lid includes a lid channel disposed on a bottom surface of the lid. The lid channel is dimensioned, shaped and positioned to be conformally disposed around the cross-beam when the garbage can is closed. A rear channel is disposed in a rear portion of the garbage can. A retraction mechanism is disposed in a bottom region of the rear channel and is configured to apply pressure to the rear surface of the lid to retract the lid into the rear channel when the garbage can is open.

### CROSS-REFERENCE TO RELATED APPLICATION

This application claims priority to U.S. Provisional Patent Application 62/127,082, filed Mar. 2, 2015, the disclosure of which is incorporated by reference herein in its entirety.

### TECHNICAL FIELD

Exemplary embodiments of the present invention relate to a garbage can. More particularly, exemplary embodiments of the present invention relate to a garbage can including a recessed lid.

### SUMMARY

Exemplary embodiments of the present invention provide a garbage can including a lid. The lid is configured to be disposed in a rear channel of the garbage can. The lid is tethered to a retracting cord coupled to a retraction mechanism disposed in the rear channel of the garbage can. The lid includes a clasp disposed on a front of the lid. The clasp is dimensioned, shaped and positioned to rest in a clasp indent disposed on the front of the garbage can. The clasp indent is configured to prevent movement of the lid.

The lid according to exemplary embodiments of the present invention may sit flushly in a lid recess disposed on a top side of the garbage can. The lid recess may include a first recessed sidewall, a second recessed sidewall and a third recessed sidewall disposed in a top of the garbage can.

The lid may include a lid channel. The lid channel may be dimensioned, shaped and positioned to be disposed around a cross-beam disposed across the top side of the garbage can. The cross-beam may be configured to prevent movement of the garbage can lid sitting flushly on the top of the garbage can.

The clasp may be configured to protrude from the rear channel across the cross-beam to serve as a handle to extract the lid disposed in the rear channel of the garbage can.

The garbage can according to exemplary embodiments of the present invention may include one or more panel slots. The one or more panel slots may be disposed on a front surface of the garbage can.

The one or more panel slots may each be configured to receive a panel. The panels may each include one or more decorative images or may include an address, house number and/or street name.

### BRIEF DESCRIPTION OF THE DRAWINGS

The above and other features of the present invention will become more apparent by describing in detail exemplary embodiments thereof, with reference to the accompanying drawings in which:

FIG. 1 is a side-view of a garbage can including a rear channel and a lid according to exemplary embodiments of the present invention.

FIG. 2 is a perspective view of an exterior of a garbage can with a lid flushly disposed on top of the garbage can according to exemplary embodiments of the present invention.

FIG. 3 illustrates an interior perspective view of a garbage can with a lid configured to be flushly disposed on top of the garbage can according to exemplary embodiments of the present invention.

FIG. 4 illustrates a panel slot with a panel lock clip according to an exemplary embodiment of the present invention.

### DETAILED DESCRIPTION

Exemplary embodiments of the present invention provide a garbage can including a lid. The lid is configured to be disposed in a rear channel of the garbage can. The lid is tethered to a retracting cord coupled to a retraction mechanism disposed in the rear channel of the garbage can. The lid includes a clasp disposed on a front of the lid. The clasp is dimensioned, shaped and positioned to rest in a clasp indent disposed on the front of the garbage can. The clasp indent is configured to prevent movement of the lid.

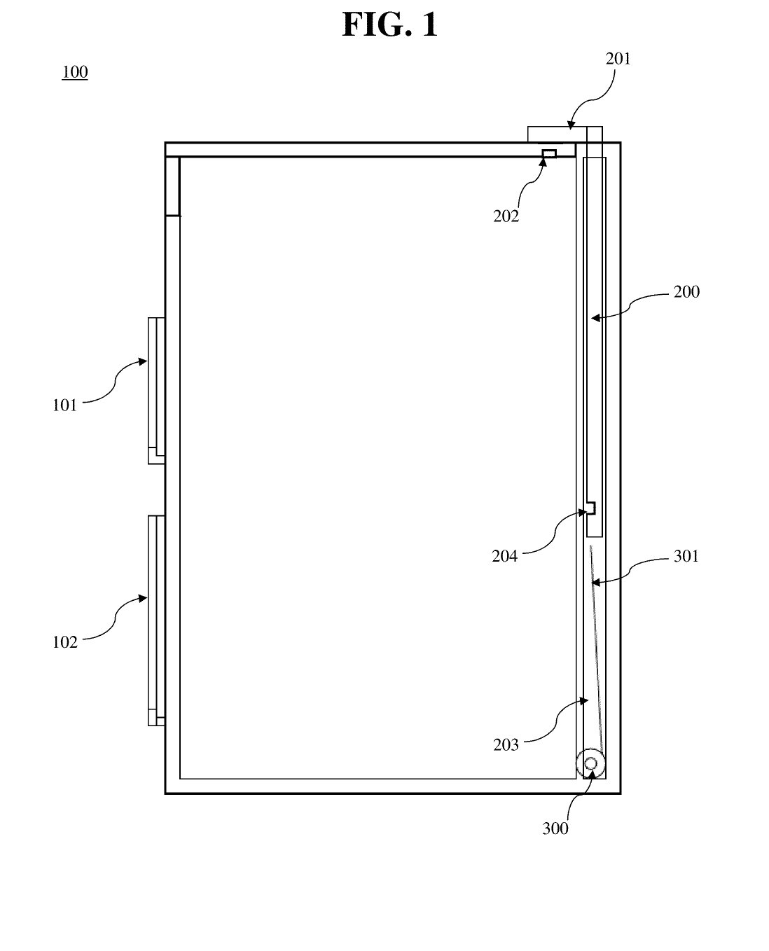

FIG. 1 is a side-view of a garbage can including a rear channel and a lid according to exemplary embodiments of the present invention.

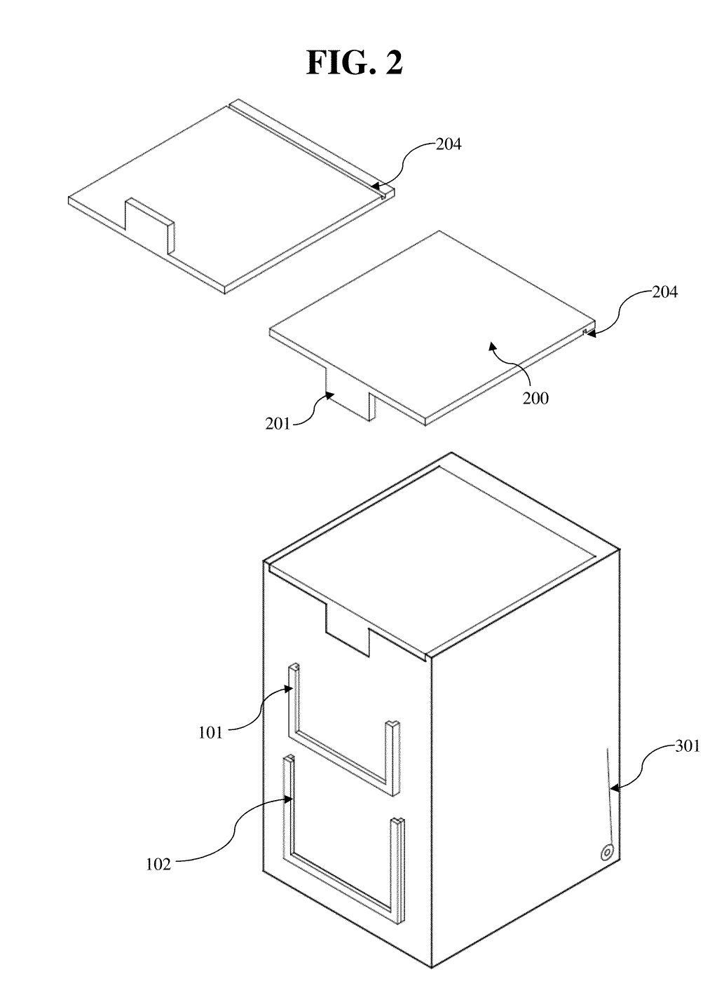

FIG. 2 is a perspective view of an exterior of a garbage can with a lid flushly disposed on top of the garbage can according to exemplary embodiments of the present invention.

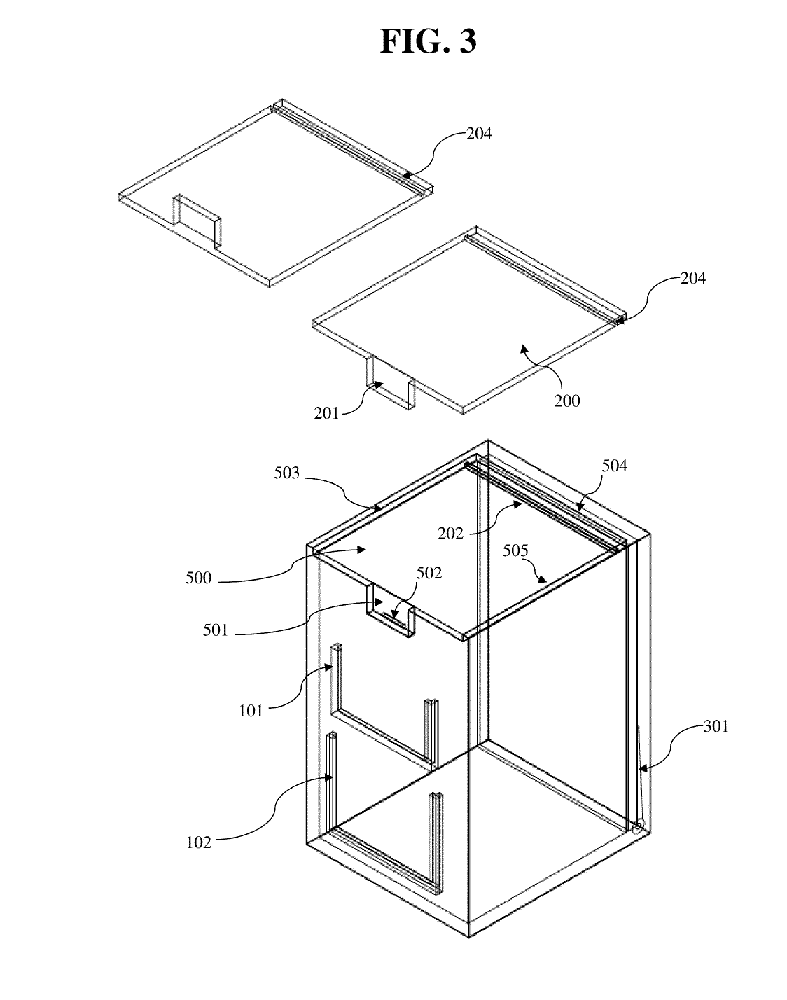

FIG. 3 illustrates an interior perspective view of a garbage can with a lid configured to be flushly disposed on top of the garbage can according to exemplary embodiments of the present invention.

Referring to FIGS. 1 to 3 a garbage can 100 may include a lid 200, a clasp 201, a cross-beam 202 and a rear channel 203. The garbage can 100 may include a retracting cord 301 and a retraction mechanism 300. The garbage can 100 may include a clasp indent 502 and a clasp lock 502.

The garbage can 100 may include plastic, rubber, a natural or synthetic polymer or any other durable material suitable for a garbage can, as understood by those of ordinary skill in the art. The garbage can 100 may be injection molded to be a single unit including all indents and panel slots, as described in more detail below.

The lid 200 according to exemplary embodiments of the present invention may be a retractable lid configured to retract into the rear channel 203 of the garbage can 100 by retracting the retracting cord 301 into the retraction mechanism 300.

The lid may include a lid channel 204. The lid channel 204 may be dimensioned, shaped and positioned to be disposed around the cross-beam 202 disposed across the top side of the garbage can 100. The cross-beam 202 may be configured to prevent movement of the garbage can lid 200 sitting flushly on the top of the garbage can 100.

According to an exemplary embodiment of the present invention, the lid channel 204 may be dimensioned, shaped and positioned to be disposed around an upper portion of a front wall of the rear channel 203. Thus, the cross-beam 202 may be omitted.

The clasp 201 may be configured to protrude from the rear channel 203 across the cross-beam 202 to serve as a handle to extract the lid 200 disposed in the rear channel 203 of the garbage can 100 (as illustrated, for example, in FIG. 1). A portion of the clasp 201 may overhang the cross-beam 202 enough to be gripped by a users' hand to pull the lid 200 out of the rear channel 203. The clap 201 may overhang enough that a users' hand could pull the lid 200 with sufficient force to overcome tension applied to the lid 200 by the retracting cord 301 coupled to the retraction mechanism 300 disposed in a bottom region of the rear channel 203.

The lid 200 may be under tension applied by the retracting cord 301. A first end of the retracting cord 301 may be coupled to a rear portion of the lid 200 and a second end of the retracting cord 301 may be coupled to the retraction mechanism 300. The retraction mechanism 300 may rotatably pull the retracting cord 301 into an inner portion thereof when the lid 200 is inserted into the rear channel 203. When the lid 200 is disposed on a top of the garbage can 100, for example in the lid recess 500, the retracting cord 301 may be pulled downward by the retraction mechanism and a rear portion of the lid 200 may thereby be substantially prevented from moving upward.

The lid 200, generally, may be disposed either in the lid recess 500 (described in more detail below) or in the rear channel 203. When the lid 200 is disposed in the lid recess 500 on the top of the garbage can 100, it may seal the top of the garbage can 100 closed so that garbage or other contents are not accessible to an outside of the garbage can 100. When the lid 200 is disposed in the lid recess 500, it may be substantially prevented from moving forward and backwards by the lid channel 204 disposed over the cross-beam 202. When the lid 200 is disposed in the lid recess 500, a front portion of the lid 200 may be substantially prevented from moving up and down by the clasp 201 disposed in the clasp indent 501 and engaged with the clasp lock 502, while a rear portion of the lid 200 may be substantially prevented from moving up and down by the retraction cord 301 being pulled downward by the retraction mechanism 300. The lid 200 may be transferred from the lid recess 500 by disengaging the clasp 201 from the clasp lock 502 and lifting the clasp 201 from the clasp indent 501. The lid 200 may be lifted upwards to elevate the lid channel 204 above the cross-beam 202. When the lid 200 is lifted upwards, downward pressure is still applied to the rear portion of the lid 200 by the retraction cord 301 coupled to the retraction mechanism 300. The lid 200 may then be inserted, rear-end first, into the rear channel 203 until the clasp 201 comes into contact with the cross-beam 202. Constant downward pressure may be applied to the lid 200 by the retracting cord 301 coupled to the rear portion of the lid 200 at the first end of the retracting cord 301. The downward pressure applied by the retracting cord 301 and the retraction mechanism 300 may hold the lid 200 in the rear channel while the garbage can 100 is moved about, as desired.

The garbage can according to exemplary embodiments of the present invention may include one or more panel slots. The one or more panel slots may be disposed on a front surface of the garbage can. The one or more panel slots may include first and second panel slots 101 and 102. The one or more panel slots may include a channel into which a decorative panel may be inserted.

The one or more panel slots may each be configured to receive the decorative panel. The panels may each include one or more decorative images or may include an address, house number and/or street name. The decorative panels may include plastic, rubber, a natural or synthetic polymer or any other durable material suitable for a garbage can, as understood by those of ordinary skill in the art. The decorative panels may be interchangeably inserted and removed into the one or more panel slots. The decorative panels may be permanently affixed in the one or more panel slots.

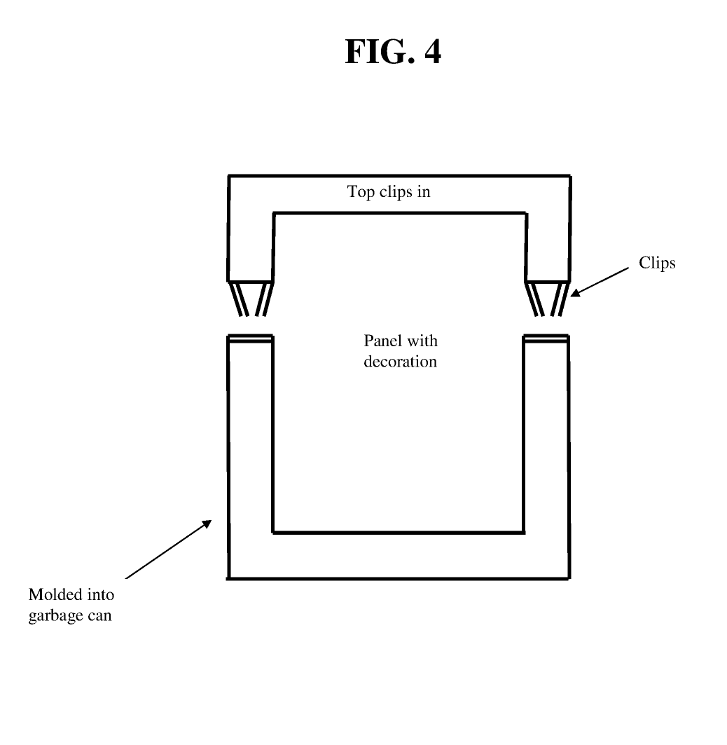

According to exemplary embodiments of the present invention, the one or more panel slots may be injection molded directly into the garbage can 100 when the garbage can 100 is formed. Alternatively, the first and second panel slots 101 and 102 may be formed separately and applied to the front of the garbage can. For example, one or more panel slots may be formed to fit a garbage can of any shape or dimensions other than the garbage can 100. The panel slots may be configured to retrofit an existing garbage can with the panel slots to display the one or more decorative panels described herein. The panel slots used to retrofit an existing garbage can may include the panel lock clips described below with reference to FIG. 4. Alternatively, the panel lock clips may be omitted.

The first and second panel slots 101 and 102 illustrated in FIGS. 1 to 3 include straight sidewalls at a substantially 90 degree angle with respect to a bottom sidewall of the first and second panel slots 101 and 101. However, according to an exemplary embodiment of the present invention, the one or more panel slot s may have angled side walls. According to an exemplary embodiment of the present invention, the panel slots may include a locking pin disposed above the panels in the face of the garbage can. The locking pin may be coupled to the face of the garbage can by a screw inserted from an inner portion of the garbage can toward on outside front of the garbage can.

The lid according to exemplary embodiments of the present invention may sit flushly in the lid recess 500 disposed on a top side of the garbage can 100. The lid recess may 500 include a first recessed sidewall 503, a second recessed sidewall 504 and a third recessed sidewall 505 disposed in a top of the garbage can 100. As illustrated, for example, in FIG. 2, when the lid 200 is disposed in the lid recess 500, it may sit flushly with top portions of the lid recess 500. The first recessed sidewall 503, the second recessed sidewall 504 and the third recessed sidewall 505 may form a 3-sided lid recess 500, which may be open in the front. Heights of the first recessed sidewall 503, the second recessed sidewall 504 and the third recessed sidewall 505 may be substantially the same as a thickness of the lid 200 so that when the lid 200 is disposed in the lid recess 500, the top of the lid 200 will be flush with tops of the first, second and third recessed sidewalls 503, 504 and 505.

The garbage can 100 may include wheels disposed on a bottom portion of the garbage can 100. The wheels may include metal, plastic, rubber, a natural or synthetic polymer, or any other appropriate material known to those of ordinary skill in the art for forming garbage can wheels. The wheels may be formed by injection molding at the time of forming the garbage can 100. The wheels may be disposed in recessed housings or may be disposed at an exterior of the garbage can 100.

FIG. 4 illustrates a panel slot with a panel lock clip according to an exemplary embodiment of the present invention.

Referring to FIG. 4, the panel slot illustrated in FIG. 4 may represent panel slots 101 or 102 illustrated in FIGS. 1 to 3. Panel slots 101 and/or 102 may include a panel lock clip. The panel lock clip may be disposed on a top portion of the panel slot 101 and/or the panel slot 102. The panel lock clip may include one or more clips that are dimensioned, shaped and positioned to snap into top portions of panel slots 101 and/or 102. The panel lock clip may secure a decorative panel disposed in the panel slots 101 or 102. The panel lock clip may prevent unwanted removal of the decorative panels disposed in the panel slot 101 and/or the panel slot 102. For example, the panel lock clip may prevent theft of the decorative panels. The panel lock clips may be secured to the panel slot 101 and/or the panel slot 102 by any desired mechanism, such as by using a screw or an attachment mechanism having a key.

While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A garbage can, comprising:
a lid recess comprising a first recessed sidewall, a second recessed sidewall and a third recessed sidewall, wherein the lid recess is formed in an upper surface of the garbage can;
a cross-beam disposed across the upper surface of the garbage can between the first recessed sidewall and the third recessed sidewall;
a lid comprising a lid channel formed in a bottom surface of the lid, wherein the lid channel is dimensioned, shaped and positioned to be conformally disposed around the cross-beam when the garbage can is closed;
a rear channel disposed in a rear portion of the garbage can, wherein a retraction mechanism is disposed in a bottom region of the rear channel; and
a retracting cord, wherein a first end of the retracting cord is coupled to a rear surface of the lid, wherein a second end of the retracting cord is coupled to the retraction mechanism, and wherein the retraction mechanism is configured to apply pressure to the rear surface of the lid to retract the lid into the rear channel when the garbage can is open.

2. The garbage can of claim 1, further comprising a clasp indent formed on a front surface of the garbage can, and a clasp disposed on a front of the lid, wherein the clasp is in communication with the clasp indent when the garbage can is closed.

3. The garbage can of claim 2, wherein a bottom surface of the clasp is in communication with an upper surface of the cross-beam when the garbage can is open.

4. The garbage can of claim 3, wherein the retraction mechanism is configured to apply constant downward pressure to the rear surface of the lid when the garbage can is open.

5. The garbage can of claim 4, wherein the clasp indent comprises a clasp lock configured to prevent the lid from moving in an upward direction when the clasp is disposed in the clasp indent.

6. The garbage can of claim 1, further comprising at least one panel slot disposed on a front of the garbage can and configured to receive an ornamental panel.

7. The garbage can of claim 6, wherein the at least one panel slot further comprises a top clip configured to lock the ornamental panel in the at least one panel slot.

8. The garbage can of claim 7, wherein the at least one panel slot comprises an upper panel slot and a lower panel slot disposed on the front of the garbage can.

9. The garbage can of claim 1, wherein the lid channel has a square shape.

10. The garbage can of claim 9, wherein an upper surface of the lid channel is recessed below the upper surface of the garbage can.
